(19) United States
(12) Patent Application Publication
(10) Pub. No.: US 2006/0034611 A1
(43) Pub. Date: Feb. 16, 2006

(54) Method and system for reducing power consumption of IrDA enabled handsets by turning on/off an IrDA port dynamically

(76) Inventor: Weidong Li, Cupertino, CA (US)

Correspondence Address: MCANDREWS HELD & MALLOY, LTD, 500 WEST MADISON STREET, SUITE 3400, CHICAGO, IL, 60661, US

(21) Appl. No.: 10/926,621

(22) Filed: Aug. 26, 2004

Related U.S. Application Data
(60) Provisional application No. 60/602,057, filed on Aug. 16, 2004.

(51) Int. Cl. H04B 10/00

(52) U.S. Cl. 398/135

(57) ABSTRACT

Certain aspects of reducing power consumption of IrDA enabled devices by dynamically turning ON/OFF an IrDA port may comprise receiving a first signal, which indicates that IrDA data is received. In response to receiving the IrDA data, a second signal such as an interrupt signal may be generated and sent to a processor. The second signal may cause the processor to wakeup from a power saving mode or state. The processor may receive a connection request and in response to the received connection request, the processor may generate and send a connection response to the IrDA enabled device. If it is determined that the IrDA enabled device has received the connection response, then an IrDA connection may be established between the processor and the IrDA enable device.

### CROSS-REFERENCE TO RELATED APPLICATIONS/INCORPORATION BY REFERENCE

This application makes reference to, claims priority to, and claims the benefit of U.S. Provisional Patent Application Ser. No. ______ (Attorney Docket No. 15804US01), filed on Aug. 16, 2004.

The above stated application is incorporated herein by reference in its entirety.

### FIELD OF THE INVENTION

Certain embodiments of the invention relate to IrDA enabled handsets. More specifically, certain embodiments of the invention relate to a method and system for reducing power consumption of IrDA enabled handsets by turning ON/OFF an IrDA port dynamically.

### BACKGROUND OF THE INVENTION

Infrared Data Association (IrDA) is a standard which specifies a way to wirelessly transfer data via infrared radiation. The IrDA specifications include standards for both physical devices and the protocols they use to communicate with each other.

An Infra-red remote control unit may be utilized to control many common consumer electronic products such as, PDA's, TV's and DVD players. When a button, for example, is pressed on the remote control unit, a signal is sent from the remote control unit to the device that contains an infra-red receiver. This signal is encoded and transmitted using a modulated carrier wave in the frequency range of 30 kHz-56 kHz, which is designated for IrDA usage. Most devices that have IrDA capability are mobile devices such as laptops, PDA's and cell phones, for example. These devices are designed to conserve battery life by switching to a sleep mode when the device is not active. In this regard, one or more processors within a particular device is configured to enter sleep mode, or some power saving mode when the device detects a period of inactivity. For example, the sleep mode automatically turns off a device after it has been unused for a predetermined period of time so as to conserve battery life. When a device is in sleep mode and data is sent to the device, the device takes a while before it wakes up and enters an operational state where it can process the received data. As a result, the device misses some of the initial characters because of the inherent delay in waking up. Even though some systems may minimize the wakeup time, characters will still be lost.

One current solution to the problem involves manually enabling or disabling the infra-red function on the handheld device or portable system by navigating through its menus. The IrDA port may be configured so that when the IrDA port is enabled, the device remains permanently active and never goes to a sleep mode, thereby increasing the power consumption. On the other hand, by disabling the infra-red port, the device goes to a sleep mode during prolonged periods of inactivity, thus causing valuable information that is sent through the infra-red port to be lost.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Certain embodiments of the invention provide a method and system for reducing power consumption of IrDA enabled devices such as handsets by turning ON/OFF an IrDA port dynamically. Aspects of the method may comprise receiving a first signal indicating that IrDA data is received. In response to receiving the first signal a second signal may be generated which causes a processor to wakeup from a low power state. The processor may receive and process IrDA data when it wakes up from the low power state. The second signal may be an interrupt signal.

A connection request may be received by the processor and an IrDA connection may be established between the processor and the IrDA enabled device, when the latter receives a response from the processor. The connection request may be a serial infra red (SIR) connect request and the processor may generate a SIR connect response in response to the connection request. It may be determined whether a SIR connect response sent by the processor is received by the IrDA enabled device. The IrDA connection may be established between the IrDA enabled device and the processor when it is determined that the SIR connect response is received.

The processor may wait for the IrDA enabled device to stop transmitting the IrDA data and a first counter may be started when the IrDA enabled device stops transmitting the IrDA data. It may be determined whether the IrDA data is being received by the processor. The first counter may be reset if the processor receives the IrDA data from the IrDA enabled device. It may be determined whether the first counter has reached a threshold value, and if so, the processor may be enabled to enter a power saving mode.

A second counter may be incremented if the IrDA enabled device doesn't receive a SIR connect response from the processor in response to a SIR connect request from the IrDA enabled device to establish a connection between the IrDA enabled device and the processor. It may also be determined whether the second counter has reached a maximum count value. The IrDA enabled device may send another SIR connect request to the processor if it is determined that the maximum count value has not been reached. If the maximum count value has been reached, the IrDA enabled device may generate a TIME OUT message indicating the inability of the IrDA enabled device to communicate with the processor.

Another embodiment of the invention may provide a machine-readable storage, having stored thereon, a computer program having at least one code section for reducing power consumption of IrDA enabled devices. The at least one code section may be executable by a machine, thereby causing the machine to perform the steps as described above for reducing power consumption of IrDA enabled devices by turning ON/OFF an IrDA port dynamically.

In accordance with another embodiment of the invention, a system for reducing power consumption of IrDA enabled devices may be provided. In this regard, the system may comprise circuitry that receives a first signal indicating received IrDA data. In response to receiving the first signal, the circuitry may generate an interrupt signal that causes a processor to wake up from a low power state. The processor may receive and process the IrDA data when it wakes up from the low power state.

The system may comprise circuitry that receives a connection request by the processor to establish a connection between the processor and the IrDA enabled device. The connection request may be a serial infra red (SIR) connect request and the system may comprise circuitry that generates a SIR connect response in response to the connection request. The system may comprise circuitry that determines whether a SIR connect response has been received by the IrDA enabled device. If the SIR connect response is received, the system may comprise circuitry that establishes the IrDA connection between the IrDA enabled device and the processor.

The system may comprise circuitry that waits for the IrDA enabled device to stop transmitting the IrDA data and starts a first counter when the IrDA enabled device stops transmitting the IrDA data. Circuitry may be utilized to determine whether the IrDA data is being received by the processor and the first counter may be reset if the processor receives the IrDA data from the IrDA enabled device. The system may further comprise circuitry that determines whether the first counter has reached a threshold value and enables the processor to enter a power saving mode when the first counter reaches a threshold value.

In another aspect of the invention, the system may comprise circuitry that increments a second counter if the IrDA enabled device doesn't receive a SIR connect response from the processor in response to a SIR connect request to establish a connection between the IrDA enabled device and the processor. The system may further comprise circuitry that determines whether the second counter has reached a maximum count value. If the maximum count value has been reached, the IrDA enabled device may comprise circuitry that may generate a TIME OUT message indicating the inability of the IrDA enabled device to communicate with the processor. Circuitry may be utilized to send another SIR connect request to the processor if the maximum count value has not been reached.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary system for reducing power consumption of IrDA enabled handsets by turning ON/OFF an IrDA port dynamically in accordance with an embodiment of the invention.

FIG. 2 is a timing diagram illustrating the exchange of messages that may be utilized in connection with the method and system for reducing power consumption of IrDA enabled handsets by turning ON/OFF an IrDA port dynamically in accordance with an embodiment of the invention.

FIG. 3 is a flowchart illustrating exemplary steps for reducing power consumption of IrDA enabled handsets by turning ON/OFF an IrDA port dynamically in accordance with an embodiment of the invention.

FIG. 4 is a flowchart illustrating exemplary steps that may be utilized for reducing power consumption of IrDA enabled handsets by turning ON/OFF an IrDA port dynamically in accordance with an embodiment of the invention.

### DETAILED DESCRIPTION OF THE INVENTION

Certain embodiments of the invention may be found in a method and system for reducing power consumption of IrDA enabled handsets by turning ON/OFF an IrDA port dynamically. In one aspect of the invention, IrDA enabled devices are designed to conserve battery life by switching to a sleep mode when they are not active. When the device receives data it triggers an interrupt controller, which sends an interrupt signal to the processor and wakes up the entire device. The wakeup process may take, for example, about 8 ms, while it may take, for example, about 6-8 seconds to establish an IrDA connection. Accordingly, this gives the processor enough time to wakeup and receive data, without loss of any valuable information.

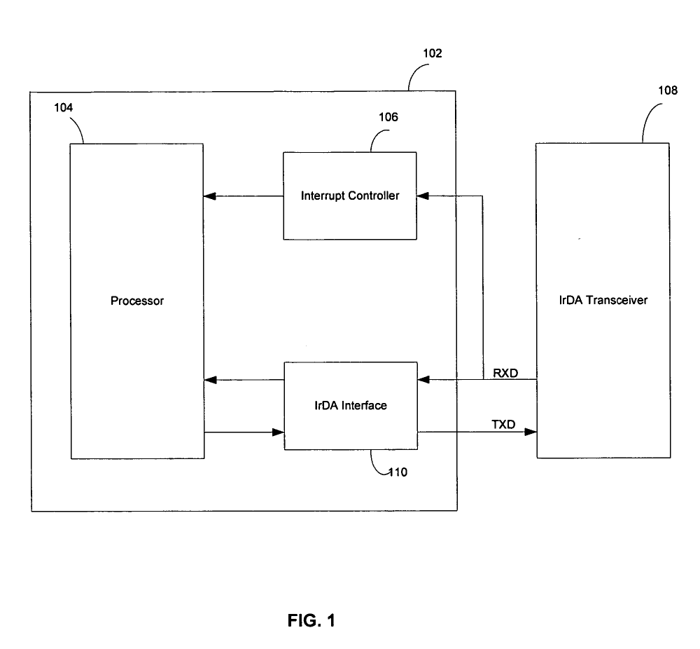

FIG. 1 is a block diagram of an exemplary system for reducing power consumption of IrDA enabled handsets by turning ON/OFF an IrDA port dynamically in accordance with an embodiment of the invention. Referring to FIG. 1, the chip 102 comprises a processor 104, an interrupt controller 106, an IrDA transceiver 108 and an IrDA interface 110.

The chip 102 may be for example, a baseband processor chip that may be utilized in, for example, GSM/GPRS/EDGE compliant devices. The chip 102 may be adapted to offer a high level of system integration, performance, and features for next generation wireless multimedia handsets and data modules. For low power consumption, accelerators are extensively used for certain necessary compute-intensive functions. The chip 102 may comprise analog and digital GSM/GPRS/EDGE baseband processing functions on a single CMOS chip, for example.

The processor 104 may be an ARM processor, for example or other suitable type of processor and is a fully synthesizable 32-bit RISC processor which monitors the activity at the IrDA port to check if any data is being received. The IrDA interface 110 may be utilized to establish an infra-red connection between the processor 104 and an IrDA transceiver 108. The IrDA transceiver 108 has an input port to receive the transmitted data TXD from the chip 102 and an output port to send the received data RXD back to the chip 102 and the interrupt controller 106. The system goes to a power saving mode such as a deep sleep mode during prolonged periods of inactivity. When the system is in a power saving mode, it may receive data RXD from the IrDA transceiver. An interrupt signal may be generated by the interrupt controller 106 in response to receiving the data RXD from the IrDA transceiver 108. The interrupt signal may cause the processor 104 to wake up from a low power state. The processor may receive and process the data when it wakes up from the low power state without losing any valuable information.

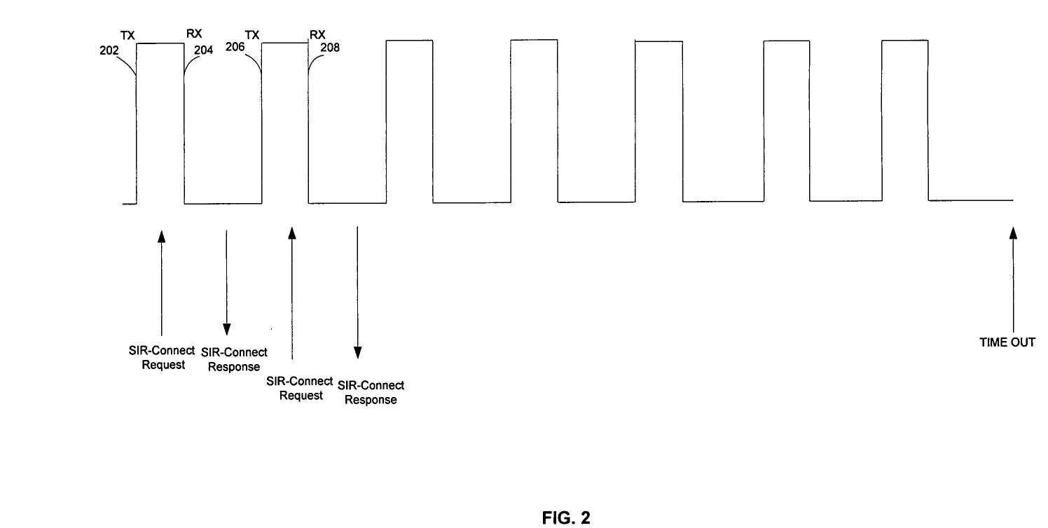

FIG. 2 is a timing diagram illustrating the exchange of messages that may be utilized in connection with the method and system for reducing power consumption of IrDA enabled handsets by turning ON/OFF an IrDA port dynamically in accordance with an embodiment of the invention. Referring to FIG. 2, on the rising edge 202, the signal is transmitted (Tx) to the IrDA transceiver and a signal is received on the falling edge 204 (Rx). Serial infra red (SIR) is basically the RS232 protocol, but with other signal levels and impulse lengths.

When the infra-red device wants to establish an IrDA connection with the RF chip it sends out a SIR-connect request and waits for a SIR-connect response. The IrDA connection is established when the IrDA transceiver receives the SIR connect response. If the IrDA transceiver doesn't receive the SIR connect response within a short period of time, it sends out another request on the rising edge 206 and waits for the SIR connect response again on the next falling edge 208. The IrDA transceiver sends out requests around 6-8 times, for example and each request period takes around 1 s. The total request period may last 6-8 seconds while the processor may wake up in about 8 ms after it receives an interrupt signal from the interrupt controller. This gives the processor enough time to wake up and be ready to receive the data from the IrDA transceiver. If the IrDA transceiver doesn't get a response after 6-8 attempts, for example, it times out and a TIME OUT message may be generated to indicate its inability to communicate with the chip.

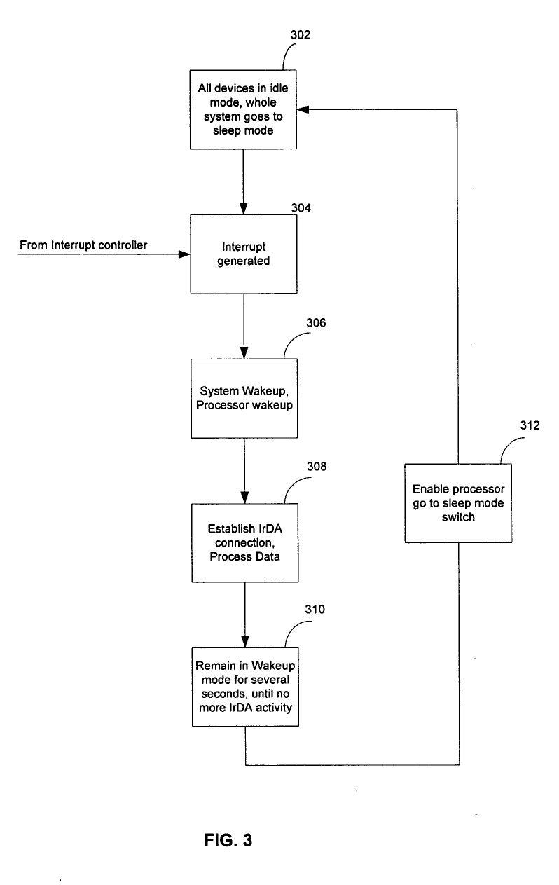

FIG. 3 is a flowchart illustrating exemplary steps for reducing power consumption of IrDA enabled handsets by turning ON/OFF an IrDA port dynamically in accordance with an embodiment of the invention. Referring to FIG. 3, in step 302, when the system remains idle for a prolonged period, the devices go to a power saving mode, such as a sleep mode to reduce power consumption. In step 304, when the chip receives data RXD from the IrDA transceiver, an interrupt signal may be generated by the interrupt controller in response to receiving the data RXD from the IrDA transceiver. In step 306, the interrupt signal wakes up the processor and the system. In step 308, the IrDA connection is then established and data is processed after the IrDA transceiver sends a SIR-connect request and receives a SIR-connect response from the processor. In step 310, the system remains in the wakeup mode for several seconds, after the IrDA activity has stopped. In step 312, the processor is enabled to switch the system back to sleep mode until it receives another interrupt signal.

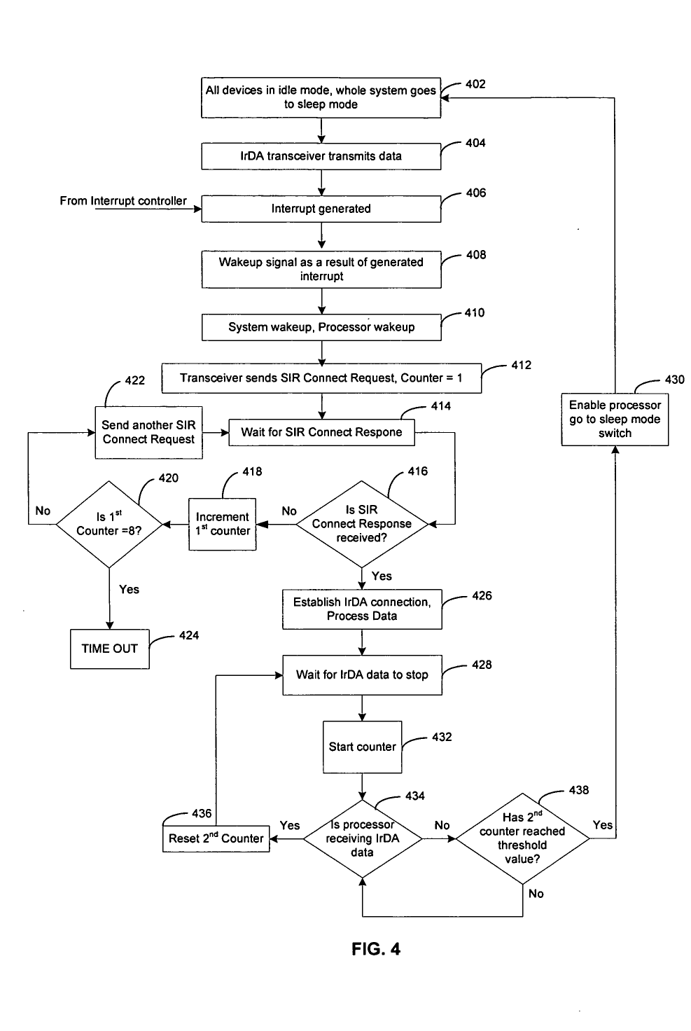

FIG. 4 is a flowchart illustrating exemplary steps that may be utilized for reducing power consumption of IrDA enabled devices by turning ON/OFF an IrDA port dynamically in accordance with an embodiment of the invention. Referring to FIG. 4, in step 402 all the devices are in idle mode when the system remains idle for a prolonged period, and the system enters a power saving mode, such as a deep sleep mode to reduce power consumption. In step 404, the IrDA transceiver transmits data to the chip. An interrupt signal may be generated by the interrupt controller, and in step 406, in response to receiving the data from the IrDA transceiver. In step 408, a wakeup signal is created as a result of the generated interrupt signal which wakes up the system and the processor as shown in step 410.

In step 412, the IrDA transceiver sends a SIR connect request to the chip and increments the first counter to 1. In step 414 the IrDA transceiver waits for a SIR connect response from the chip. In step 416, the IrDA transceiver checks if a SIR connect response has been received from the chip. If no response has been received control passes to step 418, where the first counter is incremented. In step 420, the value of the first counter is checked and if it equals the maximum value of 8, for example, then control passes to step 424, wherein the IrDA transceiver generates a TIME OUT message indicating its inability to communicate with the chip.

If the first counter in step 420 is less than the maximum value of 8, for example, then control passes to step 422, where the IrDA transceiver sends out another SIR connect request to the chip. In step 414, there is a wait for a SIR connect response from the chip. In step 416, if a SIR connect response is received, control passes to step 426. This process continues until a SIR connect response has been received by the IrDA transceiver or the system reaches a TIME OUT. In step 426, an IrDA connection is established between the processor and the IrDA transceiver and data is processed in the chip. In step 428, the system remains in wakeup mode and waits for the IrDA data to stop. In step 432, a second counter is started when the processor stops receiving the IrDA data. The system checks if the processor is receiving any more IrDA data in step 434. If the processor is receiving any more IrDA data, it resets the second counter in step 436 and returns to step 428 to wait for the IrDA data to stop. If the processor is not receiving any more IrDA data, in step 438, the second counter is checked to determine if it has reached its threshold value. If the second counter has not reached its threshold value, control passes back to step 434 where it is determined whether the processor is receiving IrDA data. If the second counter has reached its threshold value, in step 430, the processor is enabled to switch the system back to its power saving mode until it receives another interrupt signal.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for reducing power consumption of IrDA enabled devices, the method comprising:
receiving a first signal indicating received IrDA data; and
generating a second signal in response to receiving said first signal, that causes a processor to wakeup from a low power state.

2. The method according to claim 1, further comprising receiving said IrDA data by said processor when said processor wakes up from said low power state.

3. The method according to claim 1, further comprising processing said IrDA data by said processor when said processor wakes up from said low power state.

4. The method according to claim 1, wherein said second signal is an interrupt signal.

5. The method according to claim 1, further comprising:
receiving a connection request; and
establishing an IrDA connection between said processor and the IrDA enabled device.

6. The method according to claim 5, wherein said connection request is a serial infra red (SIR) connect request.

7. The method according to claim 5, further comprising generating a SIR connect response in response to said connection request.

8. The method according to claim 7, further comprising determining whether said SIR connect response is received.

9. The method according to claim 8, further comprising establishing an IrDA connection if said SIR connect response is received.

10. The method according to claim 9, further comprising waiting for said IrDA data to stop.

11. The method according to claim 10, further comprising starting a first counter.

12. The method according to claim 11, further comprising determining whether said IrDA data is received.

13. The method according to claim 12, further comprising resetting said first counter if said IrDA data is received.

14. The method according to claim 13, further comprising determining whether said first counter has reached a threshold value.

15. The method according to claim 14, further comprising enabling said processor to enter a power saving mode if said first counter has reached said threshold value.

16. The method according to claim 8, further comprising incrementing a second counter if said SIR connect response is not received.

17. The method according to claim 16, further comprising determining whether a maximum count value is reached for said second counter.

18. The method according to claim 17, further comprising generating a timeout if said maximum count value is reached.

19. The method according to claim 17, further comprising sending another SIR connect request if said maximum count value is not reached.

20. A system for reducing power consumption of IrDA enabled devices, the system comprising:
circuitry that receives a first signal indicating received IrDA data; and
circuitry that generates a second signal in response to receiving said first signal, said second signal causes a processor to wakeup from a low power state.

21. The system according to claim 20, further comprising circuitry that causes said IrDA data to be received by said processor when said processor wakes up from said low power state.

22. The system according to claim 20, wherein said processor processes said IrDA data when said processor wakes up from said low power state.

23. The system according to claim 20, wherein said second signal is an interrupt signal.

24. The system according to claim 20, further comprising:
circuitry that receives a connection request; and
circuitry that establishes an IrDA connection between said processor and the IrDA enabled device.

25. The system according to claim 24, wherein said connection request is a serial infra red (SIR) connect request.

26. The system according to claim 24, further comprising circuitry that generates a SIR connect response in response to said connection request.

27. The system according to claim 26, further comprising circuitry that determines whether said SIR connect response is received.

28. The system according to claim 27, further comprising circuitry that establishes an IrDA connection if said SIR connect response is received.

29. The system according to claim 28, further comprising circuitry that waits for said IrDA data to stop.

30. The system according to claim 29, further comprising circuitry that starts a first counter.

31. The system according to claim 30, further comprising circuitry that determines whether said IrDA data is received.

32. The system according to claim 31, further comprising circuitry that resets said first counter if said IrDA data is received.

33. The system according to claim 32, further comprising circuitry that determines whether said first counter has reached a threshold value.

34. The system according to claim 33, further comprising circuitry that enables said processor to enter a power saving mode if said first counter has reached said threshold value.

35. The system according to claim 27, further comprising circuitry that increments a second counter if said SIR connect response is not received.

36. The system according to claim 35, further comprising circuitry that determines whether a maximum count value is reached for said second counter.

37. The system according to claim 36, further comprising circuitry that generates a timeout if said maximum count value is reached.

38. The system according to claim 36, further comprising circuitry that sends another SIR connect request if said maximum count value is not reached.

39. A machine-readable storage having stored thereon, a computer program having at least one code section for reducing power consumption of IrDA enabled devices, the at least one code section being executable by a machine for causing the machine to perform steps comprising:
receiving a first signal indicating received IrDA data; and
generating a second signal in response to receiving said first signal, that causes a processor to wakeup from a low power state.

40. The machine-readable storage according to claim 39, further comprising code for receiving said IrDA data by said processor when said processor wakes up from said low power state.

41. The machine-readable storage according to claim 39, further comprising code for processing said IrDA data by said processor when said processor wakes up from said low power state.

42. The machine-readable storage according to claim 39, wherein said second signal is an interrupt signal.

43. The machine-readable storage according to claim 39, further comprising:
code for receiving a connection request; and
code for establishing an IrDA connection between said processor and the IrDA enabled device.

44. The machine-readable storage according to claim 43, wherein said connection request is a serial infra red (SIR) connect request.

45. The machine-readable storage according to claim 43, further comprising code for generating a SIR connect response in response to said connection request.

46. The machine-readable storage according to claim 45, further comprising code for determining whether said SIR connect response is received.

47. The machine-readable storage according to claim 46, further comprising code for establishing an IrDA connection if said SIR connect response is received.

48. The machine-readable storage according to claim 47, further comprising waiting for said IrDA data to stop.

49. The machine-readable storage according to claim 48, further comprising code for starting a first counter.

50. The machine-readable storage according to claim 49, further comprising code for determining whether said IrDA data is received.

51. The machine-readable storage according to claim 50, further comprising code for resetting said first counter if said IrDA data is received.

52. The machine-readable storage according to claim 51, further comprising code for determining whether said first counter has reached a threshold value.

53. The machine-readable storage according to claim 52, further comprising code for enabling said processor to enter a power saving mode if said first counter has reached said threshold value.

54. The method according to claim 46, further comprising code for incrementing a second counter if said SIR connect response is not received.

55. The machine-readable storage according to claim 54, further comprising code for determining whether a maximum count value is reached for said second counter.

56. The machine-readable storage according to claim 55, further comprising code for generating a timeout if said maximum count value is reached.

57. The machine-readable storage according to claim 55, further comprising code for sending another SIR connect request if said maximum count value is not reached.
